(19) United States
(12) Patent Application Publication
(10) Pub. No.: US 2025/0196397 A1
(43) Pub. Date: Jun. 19, 2025

(54) POLYURETHANE ELASTIC FIBER AND METHOD FOR PRODUCING SUCH

(71) Applicant: TORAY-OPELONTEX CO., LTD., Kita-ku, Osaka (JP)

(72) Inventors: Kazuki NAESHIRO, Otsu City, Shiga (JP); Toshihiro TANAKA, Otsu City, Shiga (JP)

(21) Appl. No.: 18/847,822

(22) PCT Filed: Mar. 16, 2023
(86) PCT No.: PCT/IB2023/052602

§ 371 Date: Sep. 17, 2024

(30) Foreign Application Priority Data
Mar. 18, 2022 (JP) 2022-043563

(51) Int. Cl. B29B 17/02; B29B 17/04; B29D 99/00; B29K 75/00; B29K 105/08; C08J 11/06; D01D 1/02; D01D 5/00; D01F 6/70

(52) U.S. Cl. CPC B29B 17/02; B29B 17/0404; C08J 11/06; D01D 1/02; D01D 5/003; D01F 6/70; B29B 2017/0244; B29D 99/0078; B29K 2075/00; B29K 2105/0809; B29K 2995/0046; D10B 2331/10; D10B 2401/061; D10B 2501/02

(57) ABSTRACT

To provide a recycled-material polyurethane elastic fiber using recovered fabric containing a polyurethane fiber and a final product as raw materials, and a method for producing such. A recycled-material polyurethane elastic fiber using a recovered fabric containing a polyurethane fiber, wherein a component separated by wet gravity separation of the fabric is used as at least a portion of raw materials, and a method for producing such.

### TECHNICAL FIELD

The present invention relates to a polyurethane elastic fiber, and more particularly to a polyurethane elastic fiber using recycled polyurethane fibers as at least a portion of raw materials and a method for producing such.

### BACKGROUND ART

In recent years, contributions to sustainable development goals (SDGs) have been demanded, and recyclable resource utilization is the most important issue for all industrial products. For example, in the case of polyurethane elastic fibers, art is known for recovering and recycling fiber waste generated in the production process and required fibers from used products. Art for dissolving and recycling fiber waste has been known for a long time as in Patent Literature 1 and Patent Literature 2. Furthermore, as in Patent Literature 3 and Patent Literature 4, art for producing a cascade-type recycled yarn in which a polyurethane material is finely divided as a raw material and then dissolved using a solvent has also been discovered in recent years.

However, in the horizontal recycling of polyurethane elastic fibers to polyurethane elastic fibers, there are problems peculiar to polyurethane elastic fibers. For example, there was a concept of recovering polyurethane from a wound body of polyurethane elastic fibers in a process, but there was no concept of recovering polyurethane from a fabric containing polyurethane elastic fibers. This is because the content of polyurethane elastic fibers in the fabric is small, and the idea of recovering them had not been considered. Furthermore, in the conventional way of thinking, it has been considered that dissolution is essential for effective recovery of polyurethane (Patent Literature 3).

### PRIOR ART LITERATURE

### Patent Literature

[Patent Literature 1] Japanese Unexamined Patent Application Publication No. S56-122836
[Patent Literature 2] Japanese Examined Patent Application Publication No. S57-42657
[Patent Literature 3] CN101096781
[Patent Literature 4] Japanese Unexamined Patent Application Publication No. (Translation of PCT Application) 2002-538314

### Outline of Invention

### Problem to be Solved by Invention

An object of the present invention is to provide a polyurethane elastic fiber containing polyurethane obtained by recycling materials. More particularly, an object of the present invention is to provide a recycled-material polyurethane elastic fiber in which fiber-to-fiber recycling can be efficiently performed in which a recovered fabric containing a polyurethane fiber and a final product are used as raw materials and reused for the same material and application as horizontal recycling, and a method for producing the same.

### Means for Solving Problem

When the recovered fabric containing a polyurethane elastic fiber itself is used as a raw material to recover polyurethane, it is necessary to separate polyurethane from other fibers such as nylon and polyester. Furthermore, if chemical recycling or material recycling is performed on the recovered fabric remaining after polyurethane recovery, the polyurethane in the recovered fabric is recovered at as high a recovery rate as possible and it is desirable that no polyurethane remains in the recovered fabric. In contrast, the inventors of the present invention have found that by using a wet gravity separation method, fibers other than polyurethane can be easily separated from polyurethane, and polyurethane can be obtained at a high recovery rate. They also found that by blending highly accurately recovered polyurethane with virgin polymer, it is possible to obtain a polyurethane elastic fiber containing recycled polyurethane, which also enables horizontal recycling of polyurethane elastic fibers.

That is, the present invention has the following configurations.

(1) A recycled-material polyurethane elastic fiber using a recovered fabric containing a polyurethane fiber, wherein a component separated by wet gravity separation of the fabric is used as at least a portion of raw materials.
(2) The polyurethane elastic fiber of (1), wherein the fabric is subjected to the wet gravity separation by being pulverized to a size of 0.005 mm or more and 0.5 mm or less.
(3) The polyurethane elastic fiber of (1) or (2), wherein a surfactant is used in the wet gravity separation.
(4) The polyurethane elastic fiber of (3), wherein the surfactant is an ionic surfactant that is liquid at room temperature.
(5) The polyurethane elastic fiber of (3) or (4), wherein a concentration of the surfactant is in a range of 0.1% by mass or more and 50% by mass or less.
(6) The polyurethane elastic fiber of any among (1) to (5), wherein an ultrasonic wave is used in the wet gravity separation.
(7) The polyurethane elastic fiber of (6), wherein an intensity of the ultrasonic wave has an output of 20 W or more and 2,000 W or less per 1 kg of a heavy liquid of wet gravity separation wherein the fabric is soaked, and a frequency of the ultrasonic wave is in a range of 20 kHz or more and 100 kHz or less.
(8) The polyurethane elastic fiber of any among (1) to (7), wherein a specific gravity of a heavy liquid of the wet gravity separation is in a range of 1.10 or more and 2.40 or less.
(9) The polyurethane elastic fiber of any among (1) to (8), wherein a bath ratio (heavy-liquid mass:fabric mass) of the wet gravity separation is in a range of 20:1 to 500:1.
(10) The polyurethane elastic fiber according to any among (1) to (9), wherein the heavy liquid for the wet gravity separation is an aqueous calcium chloride solution.
(11) The polyurethane elastic fiber of any among (1) to (10), wherein a number-average molecular weight based on gel permeation chromatography (GPC) of the polyurethane contained in the fabric is 20,000 or more and 120,000 or less, and no peak or shoulder is present in a detection intensity curve in a region wherein this molecular weight based on GPC is 30,000 or less.
(12) The polyurethane elastic fiber of any among (1) to (11), wherein Av C—O 1,730 cm-1/Av C═O 1,710 cm-1 based on an infrared spectrum (IR) of the polyurethane fiber contained in the fabric is 1.05 or more and 1.50 or less.
(13) The polyurethane elastic fiber of any among (1) to (12), wherein application of the fabric is as a clothing product that is washed with high frequency.
(14) The polyurethane elastic fiber of (13), wherein application of the fabric is as an undergarment.
(15) A method for producing a recycled-material polyurethane elastic fiber using a recovered fabric containing a polyurethane fiber, wherein a component separated by wet gravity separation of the fabric is used as at least a portion of raw materials.
(16) The method for producing a polyurethane elastic fiber of (15), wherein the fabric is subjected to the wet gravity separation by being pulverized to a size of 0.005 mm or more and 0.5 mm or less.
(17) The method for producing a polyurethane elastic fiber of (15) or (16), wherein a surfactant is used in the wet gravity separation.
(18) The method for producing a polyurethane elastic fiber of (17), wherein the surfactant is an ionic surfactant that is liquid at room temperature.
(19) The method for producing a polyurethane elastic fiber of (17) or (18), wherein a concentration of the surfactant is in a range of 0.1% by mass or more and 50% by mass or less.
(20) The method for producing a polyurethane elastic fiber of any among (15) to (19), wherein an ultrasonic wave is used in the wet gravity separation.
(21) The method for producing a polyurethane elastic fiber of (20), wherein an intensity of the ultrasonic wave has an output of 20 W or more and 2,000 W or less per 1 kg of a heavy liquid of wet gravity separation wherein the fabric is soaked, and a frequency of the ultrasonic wave is in a range of 20 kHz or more and 100 kHz or less.
(22) The method for producing a polyurethane elastic fiber of any among (15) to (21), wherein a specific gravity of a heavy liquid of the wet gravity separation is in a range of 1.10 or more and 2.40 or less.
(23) The method for producing a polyurethane elastic fiber of any among (15) to (22), wherein a bath ratio (heavy-liquid mass:fabric mass) of the wet gravity separation is within 20:1 to 500:1.
(24) The method for producing a polyurethane elastic fiber according to any among (15) to (23), wherein the heavy liquid for the wet gravity separation is an aqueous calcium chloride solution.

### Effect of Invention

According to the present invention, a high recovery rate of polyurethane can be realized by performing wet gravity separation using a recycled fabric containing a polyurethane fiber as a raw material. Moreover, it is possible to provide a polyurethane elastic fiber having sufficient function as a polyurethane elastic fiber even if the polyurethane elastic fiber contains a large amount of recycled polyurethane.

### Mode for Carrying Out Invention

The present invention will be described in detail below along with embodiments.

First, the polyurethane used as the main component in the polyurethane elastic fiber of the present invention will be described. Here, the main component is a component contained in the polyurethane elastic fiber in an amount exceeding 50% by mass.

The polyurethane used in the present invention is not particularly limited and may be any polyurethane as long as it has a structure having polymer diol and diisocyanate as the starting materials. Moreover, the synthetic method is also not particularly limited. That is, for example, it may be a polyurethane urea composed of a polymer diol, a diisocyanate, and a low molecular weight diamine as a chain extender, or a polyurethane urethane composed of a polymer diol, a diisocyanate, and a low molecular weight diol as a chain extender. Furthermore, it may be a polyurethane urea using a compound having a hydroxyl group and an amino group in the molecule as a chain extender. It is also preferable to use trifunctional or higher polyfunctional glycols, isocyanates, and the like as long as the effects of the present invention are not hindered. Furthermore, the processing method is not particularly limited. That is, the polyurethane may be recycled through re-molding and re-spinning.

For polymer diols, polyether diols, polyester diols, polycarbonate diols, and the like are preferable. In particular, in terms of imparting flexibility and elongation to the yarn, it is preferable to use a polyether-based diol.

Preferably used polyether-based diols include, for example, polyethylene oxide, polyethylene glycol, derivatives of polyethylene glycol, polypropylene glycol, polytetramethylene ether glycol (hereinafter sometimes abbreviated as PTMG), modified PTMG which is a copolymer of tetrahydrofuran (hereinafter sometimes abbreviated as THF) and 3-methyltetrahydrofuran, modified PTMG which is a copolymer of THF and 2-methyltetrahydrofuran, modified PTMG which is a copolymer of THF and 2,3-dimethylTHF, a polyol having side chains on both sides such as that disclosed in U.S. Pat. No. 2,615,131, random copolymers in which THF and ethylene oxide and/or propylene oxide are arranged irregularly, and the like. These polyether-based diols may be used alone or as a mixture or copolymer of two or more.

Furthermore, in terms of obtaining abrasion resistance and light resistance as a polyurethane elastic fiber, polyester-based diols such as butylene adipate, polycaprolactone diol, and polyester polyols having side chains disclosed in Japanese Unexamined Patent Application Publication No. S61-26612, and the like, and polycarbonate diols disclosed in Japanese Examined Patent Application Publication No. H2-289516 and the like are preferably used.

Moreover, these polymer diols may be used alone or as a mixture or copolymer of two or more.

For the molecular weight of the polymer diol, the number average molecular weight is preferably 1,000 or more and 8,000 or less, and further preferably 1,500 or more and 6,000 or less in terms of obtaining elongation, strength, heat resistance, and the like when made into yarn. Using a polyol having a molecular weight within this range makes it possible to easily obtain an elastic yarn having excellent elongation, strength, elastic recovery force, and heat resistance.

Next, as the diisocyanate, aromatic diisocyanates such as diphenylmethane diisocyanate (hereinafter sometimes abbreviated as MDI), tolylene diisocyanate, 1,4-diisocyanatobenzene, xylylene diisocyanate, and 2,6-naphthalene diisocyanate are particularly suitable for synthesizing polyurethane having high heat resistance and strength. Furthermore, as the alicyclic diisocyanate, for example, methylene bis(cyclohexyl isocyanate), isophorone diisocyanate, methylcyclohexane 2,4-diisocyanate, methylcyclohexane 2,6-diisocyanate, cyclohexane 1,4-diisocyanate, hexahydroxylylene diisocyanate, hexahydrotolylene diisocyanate, octahydro 1,5-naphthalenediisocyanate, and the like are preferable. The alicyclic diisocyanate can be effectively used particularly for suppressing yellowing of polyurethane elastic yarn. These diisocyanates may be used alone or in combination of two or more.

At least one of a low molecular weight diamine and a low molecular weight diol is preferably used as the chain extender used in synthesizing the polyurethane. Note that one having both a hydroxyl group and an amino group in one molecule, such as ethanolamine, may be used.

Preferable low molecular weight diamines include, for example, ethylenediamine, 1,2-propanediamine, 1,3-propanediamine, hexamethylenediamine, p-phenylenediamine, p-xylylenediamine, m-xylylenediamine, p,p′-methylenedianiline, 1,3-cyclohexyldiamine, hexahydrometaphenylenediamine, 2-methylpentamethylenediamine, bis(4-aminophenyl)phosphine oxide and the like. It is preferable to use one or more of these. Ethylenediamine is particularly preferable. By using ethylenediamine, a yarn having excellent elongation, elastic recovery, and heat resistance can be easily obtained. A triamine compound capable of forming a crosslinked structure, such as diethylenetriamine, may be added to these chain extenders to an extent that the effect is not lost.

Furthermore, typical low molecular weight diols include ethylene glycol, 1,3-propanediol, 1,4-butanediol, bishydroxyethoxybenzene, bishydroxyethylene terephthalate, and 1-methyl-1,2-ethanediol, and the like. It is preferable to use one or more of these. Ethylene glycol, 1,3-propanediol and 1,4-butanediol are particularly preferable. When these are used, the heat resistance of the diol-extended polyurethane becomes higher, and a yarn with higher strength can be obtained.

Furthermore, in the present invention, for the molecular weight of the polyurethane, it is preferable for the number average molecular weight to be within the range of 30,000 or more and 150,000 or less in terms of obtaining a polyurethane elastic fiber having high durability and strength. Note that the molecular weight is measured by GPC and converted by polystyrene.

It is also preferable to use one or a mixture of two or more terminal blocking agents in the polyurethane. Preferable terminal blocking agents include monoamines such as dimethylamine, diisopropylamine, ethylmethylamine, diethylamine, methylpropylamine, isopropylmethylamine, diisopropylamine, butylmethylamine, isobutylmethylamine, isopentylmethylamine, dibutylamine, and diamylamine, monools such as ethanol, propanol, butanol, isopropanol, allyl alcohol, and cyclopentanol, and monoisocyanates such as phenylisocyanate.

In the recycled-material polyurethane elastic fiber according to the present invention, the polyurethane elastic fiber made of polyurethane having the basic structure as described above is configured as a polyurethane elastic fiber using recycled polyurethane elastic fiber as at least a portion of the raw materials, and in particular, the present invention is configured as a polyurethane elastic fiber wherein recovered fabric containing a polyurethane fibers is used as at least a portion of the raw materials. Here, the recycled-material polyurethane elastic fiber includes those recovered from the form of fabric, recovered from the form of general consumer products such as underwear, and recovered from repeated recycling. The recovery method is not particularly limited, and recycled polyurethane elastic fibers recovered by any method are included.

The term “material recycling” as used in the present invention refers to reusing the polyurethane of the recovered polyurethane elastic fiber as a raw material for new polyurethane elastic fibers without reducing the molecular weight or monomerizing it.

In a polyurethane elastic fiber wherein the recovered fabric containing the polyurethane fiber of the present invention is used as at least a portion of the raw materials, a first characteristic is that the recycled polyurethane fiber used as the raw material is recovered by wet gravity separation. Wet gravity separation in the present invention is a method wherein products recovered in the form of a fabric and general consumer products such as underwear are pulverized into fine-sized fiber waste using a pulverizer, then separated using a heavy liquid according to the difference in specific gravity of each of the fibers, and selectively recovering the polyurethane fibers.

Note that the fabric may be composed only of polyurethane fibers. The reason for this is that wet gravity separation makes it possible to obtain recycled polyurethane fibers that are more refined and serve as a raw material of good quality.

In the present invention, pulverization of fabric means, for example, in the case of apparel products, the apparel products themselves are cut and subjected to wet gravity separation.

The size at the time of pulverization depends on the size of the screen opening of the pulverizer. For example, a size of 0.5 mm or less means a pulverized fiber discharged through a 0.5 mm hole in the screen of the pulverizer.

In addition, the fabric in the present invention mainly refers to a mixed fabric with any fiber regardless of the content of polyurethane. However, it may also be a fabric composed only of polyurethane fibers. Fibers other than polyurethane in the mixed fabric include, for example: as typical synthetic fibers, polyester fibers obtained from polyester-based resin having polyethylene terephthalate, polybutylene terephthalate, polyethylene terephthalate, polytetramethylene glycol terephthalate, or these structural units as main constituents, and other copolymer components copolymerized, and polyethylene terephthalate-based fibers, that is, fibers in which the main polymer is polyethylene terephthalate or copolymerized polyethylene terephthalate, are preferred. For example, fibers made up of those having polyethylene terephthalate, polybutylene terephthalate, or ethylene terephthalate units as the main repeating component (specifically 90 mol % or more of the repeating units), those having butylene terephthalate units as the main repeating component (specifically repeating 90 mol % or more of the repeating units), and the like can be preferably used. Among these, fibers made of polyester containing 90 mol % or more of ethylene terephthalate units as repeating components are preferable, and fibers made of polyester containing 95 mol % or more of ethylene terephthalate units as repeating components are further preferable. It is even further preferable that the fiber is made of polyester having 100 mol % of ethylene terephthalate units as a repeating component (that is, polyethylene terephthalate). This polyethylene terephthalate-based fiber has good texture, gloss, and easy care such as resistance to wrinkles, and is suitable as a fiber material for constructing stretchable fabrics. In addition, polyethylene terephthalate-based fiber is suitable when used in combination with polyurethane urea-based elastic yarns that are preferably used in the present invention, and can be made into favorable stretch fabrics. Further, for example, cellulose fibers are typical examples of semi-synthetic fibers and natural fibers. Examples of these cellulose fibers include natural cellulose fibers such as cotton and hemp, regenerated cellulose fibers such as rayon, semi-synthetic cellulose fibers, and so-called unspecified fibers (Lyocell and Cupra).

Furthermore, the number of fibers to be mixed is preferably as small as possible, preferably six or less. Three is further preferable, and two is most preferable. An example is a double mixed fabric of polyurethane elastic fiber and polyester fiber.

When performing the wet gravity separation as described above, in order to recover polyurethane fibers at a higher yield, it is desirable that the bath ratio (heavy liquid mass:pulverized fabric mass) is in the range of 20:1 to 500:1. A further preferable range is 30:1 to 300:1. An even more preferable range is 40:1 to 250:1. Furthermore, a heavy liquid is required when performing wet gravity separation, and solutes for preparing the heavy liquid include sodium chloride, calcium chloride, sodium polytungstate, bromoform, tetrabromoethane, and methylene iodide. Further preferable are sodium chloride, calcium chloride, and sodium polytungstate, which have a relatively small environmental burden in terms of safety to the body, consideration for the environment, and the like. Moreover, it is preferable that the solvent of the heavy liquid does not dissolve the introduced fibers as much as possible. More specifically, in addition to water, water-soluble solvents such as alcohols and ketones are also preferred, and if the amount is small, a non-aqueous solvent may be suspended and used together with the surfactant.

When performing the wet gravity separation as described above, the specific gravity of the heavy liquid used is preferably in the range of 1.10 to 2.40. More preferably, the specific gravity is in the range of 1.10 to 2.00 because typical fibers to be separated, such as polyurethane and polyester, have a specific gravity in the range of 1.0 to 2.0. An even more preferable range is 1.20 to 1.40.

The temperature at which heavy liquid specific gravity separation is performed is preferably in the range of 20° C. to 70° C., and further preferably in the range of 30° C. to 45° C. in terms of the solubility of the solute.

A surfactant may be used as an additive to further improve the recovery rate of polyurethane fibers in wet gravity separation. The surfactant attaches to the fiber surface and reduces the friction between fiber surfaces, and the entanglement between the fibers is therefore eliminated and the recovery rate of the polyurethane is remarkably improved. Furthermore, not only can the recovery rate be significantly improved, but the influence of metal soap accumulated due to recycling can also be reduced, and when the surfactant content in the yarn is 0.003% by mass or more and 0.5% by mass or less, practically preferable properties of the polyurethane elastic fiber, particularly preferable winding shape and breaking strength and elongation are ensured.

More specifically, examples of the surfactant to be used include nonionic surfactants, anionic surfactants, cationic surfactants, amphoteric surfactants, and the like, and more preferably, ionic surfactants that are liquid at room temperature such as anionic surfactants and cationic surfactants are desirable in terms of easily attaching to each fiber.

Examples of nonionic surfactants used in the present invention include polyoxyethylene alkyl ethers, alkyl monoglyceryl ethers, polyoxyethylene alkylamines, fatty acid sorbitan esters, and fatty acid diethanolamides. Among these, the so-called hydrophilic portion (hydrophil) of the surfactant is preferably of an ether type, and is preferably at least one of, for example, an ethylene oxide polymer, a propylene oxide polymer, and a copolymer of ethylene oxide and propylene oxide. By containing, as a nonionic surfactant, at least one of a terminal-modified derivative of an ethylene oxide polymer, a terminal-modified derivative of a propylene oxide polymer, and a terminal-modified derivative of a copolymer of ethylene oxide and propylene oxide, for example, antibacterial properties can be improved while improving spinnability. The so-called hydrophobic portion (hydrophob) of the surfactant is the above-described terminal-modified structure, and is preferably an alkyl group, a phenyl group, or a styrenated phenyl group, and specifically, polyoxyethylene stearyl ether, polyoxyethylene lauryl ether, polyoxyethylene ethylphenol ether, polyoxyethylene propylphenol ether, polyoxyethylene styrenated phenyl ether, polyoxyethylene sorbitol tetraoleate and the like are examples of nonionic surfactants. Polyoxyethylene styrenated phenyl ethers are further preferable, and examples of such include polyoxyethyleneoxypropylene tris-styrenated phenyl ether, polyoxyethyleneoxypropylene distyrenated phenyl ether, polyoxyethyleneoxypropylene monostyrenated phenyl ether, polyoxyethyleneoxypropylene-2,4,6-tris(α,α-ether, polyoxyethyleneoxypropylene-2,4-bis(α,α-dimethylbenzyl)phenyl dimethylbenzyl)phenyl ether, polyoxyethyleneoxypropylene-2-mono(α,α-dimethylbenzyl)phenyl ether, polyoxyethyleneoxypropylene-4-mono(α,α-dimethylbenzyl)phenyl ether. Most preferably, the mol number added to these styrene groups has a distribution and a mixture thereof is used.

Further, the ionic surfactants used in the present invention include, for example, anionic surfactants such as alkylbenzenesulfonates such as sodium dodecylbenzenesulfonate; dialkyl sulfosuccinates such as sodium di-2-ethylhexylsulfosuccinate and sodium diisotridecylsulfosuccinate; dipolyoxyethylene alkyl ether sulfosuccinates such as di(polyoxyethylene 2-ethylhexyl ether) sodium sulfosuccinate and di(polyoxyethylene isotridecyl ether) sodium sulfosuccinate; polyoxyalkylene alkyl ether sulfates such as sodium polyoxyethylene lauryl ether sulfate and sodium polyoxyethylene myristyl ether sulfate; alkyl sulfates such as sodium lauryl sulfate, higher alcohol sodium sulfate, triethanolamine lauryl sulfate, and ammonium lauryl sulfate; fatty acid salts such as potassium oleate, sodium oleate, semi-hardened sodium tallow fatty acid, and the like.

Furthermore, examples of cationic surfactants include alkyltrimethylammonium salts such as lauryltrimethylammonium chloride, cetyltrimethylammonium bromide, and stearyltrimethylammonium chloride; and alkyldimethylbenzylammonium salts such as stearyldimethylbenzylammonium chloride, benzalkonium chloride, and lauryldimethylbenzylammonium chloride.

It is desirable for the concentration of the surfactant in the heavy liquid used for the wet gravity separation to be in the range of 0.1% by mass or more and 50% by mass or less. In terms of controlling the specific gravity of the heavy liquid, a more preferable range is 0.1% by mass or more and 30% by mass or less. An even more preferable range is 0.1% by mass or more and 10% by mass or less. Moreover, in terms of easily controlling the concentration of the surfactant, it is also preferable that a property of the surfactant is to be liquid at room temperature.

An ultrasonic wave may be used as in wet gravity separation to further improve the recovery rate of polyurethane fibers in wet gravity separation. Equipment such as an ultrasonic wave homogenizer or an ultrasonic wave washing machine may be used as the device for generating ultrasonic waves. The shape of the horn that generates ultrasonic waves is also not particularly limited. It is desirable for the intensity of the ultrasonic wave used to be within the range of 20 W or more and 2000 W or less, more preferably 50 W or more and 1200 W or less per kg of the heavy liquid of the wet gravity separation in which the fabric is immersed. Furthermore, it is desirable for the frequency to be in the range of 20 kHz or more and 100 kHz or less.

In the present invention, it is desirable to wash the polyurethane fibers recovered by wet gravity separation with water in terms of suppressing deterioration of the properties of the recycled polyurethane elastic fibers due to adhesion of salts in the heavy liquid. By washing with water, it is possible to remove solutes and surfactants in the heavy liquid, thereby preventing changes in the properties of the recycled polyurethane elastic fibers. In terms of solubility in water, it is desirable for the washing temperature to be in the range of 20° C. to 80° C.

When the polyurethane elastic fiber of the present invention contains a surfactant, this is preferably contained at 0.003% by mass or more and 3.0% by mass or less. Surfactants can reduce the effects of metal soaps accumulated by recycling, and surfactants have moderate sustained release and mild accumulation when polyurethane elastic fibers are used. When the content of the surfactant is within this range, practically preferable properties of the polyurethane elastic fiber, particularly winding shape and breaking strength and elongation, are ensured. A more preferable surfactant content is a range of 0.03% by mass or more and 2.5% by mass or less, and a further preferable range is 0.3% by mass or more and 2.0% by mass or less.

Further, the content of the surfactant in the recycled polyurethane elastic fiber that is recovered and used as a raw material is preferably in a range of 0.003% by mass or more and 0.5% by mass or less. When the content of the surfactant in the recycled polyurethane elastic fiber is within this range, the content of the surfactant contained in the polyurethane elastic fiber that is finally produced can be easily controlled to the desirable surfactant content described above. The surfactant content of the recycled polyurethane elastic fiber is more preferably 0.03% by mass or more and 0.25% by mass or less and still more preferably in a range of 0.05% by mass or more and 0.2% by mass or less.

In the present invention, when a quaternary ammonium salt, which is a cationic surfactant, is used in combination, the antibacterial activity varies depending on the chain length of the alkyl group in the ammonium ion, and a quaternary ammonium salt having high antibacterial activity is desirable. However, from the viewpoint of suppressing thermal decomposition due to the heat received during production of the polyurethane elastic yarn, it is preferable to select a large chain type and chain length for the alkyl group or the like—that is, an alkyl group or the like having a large number of carbon atoms. In addition, it is preferable to contain an antibacterial agent from a sanitary point of view as well, given that old clothes and the like are being recycled. Particularly preferred ammonium ions from this point of view are didecyldimethylammonium ion, oleyltrimethylammonium ion and the like. These are usually supplied by inorganic salts such as chlorides, bromides and iodides and organic acid salts such as sulfonates, carboxylates and phosphates. Among these, sulfonates and carboxylates are preferred from a viewpoint of stability in terms of discoloration, heat resistance and the like.

Specific examples of the salt having the above structure include didecyldimethylammonium trifluoromethylsulfonate, di-n-decyldimethylammonium trifluoromethanesulfonate, di-n-decyldimethylammonium pentafluoroethanesulfonate, n-hexadecyltrimethylammonium trifluoromethanesulfonate and benzyldimethyl coconut oil alkylammonium pentafluoroethanesulfonate.

The quaternary ammonium salt-based antibacterial agent is preferably contained in a range of 0.1% by mass or more and 5% by mass or less with respect to the total mass of the polyurethane elastic yarn from the viewpoint of expressing antibacterial properties and maintaining a balance between discoloration and stretchability.

When the polyurethane elastic fiber of the present invention contains an antioxidant, this is preferably contained at 0.002% by mass or more and 5.0% by mass or less. When the content of the antioxidant is within this range, the properties of the polyurethane elastic fiber that are practically preferable, and the particularly preferable antioxidant is a hindered phenol compound, and phenol compounds generally known as antioxidants are mentioned. For example, 3,5-di-t-butyl-4-hydroxy-toluene, n-octadecyl-β-(4′-hydroxy-3′,5′-di-t-butylphenyl) propionate, tetrakis[methylene-3-(3′,5′-di-t-butyl-4′-hydroxyphenyl)propionate]methane, 1,3,5-trimethyl-2,4,6′-tris(3,5-di-t-butyl-4-hydroxybenzyl)benzene, calcium (3,5-di-t-butyl-4-hydroxy-benzyl-monoethyl-phosphate), triethylene glycol-bis[3-(3-t-butyl-5-methyl-4-hydroxyphenyl)propionate], 3,9-bis[1,1-dimethyl-2-{β-(3-t-butyl-4-hydroxy-5-methylphenyl)propionyloxy}ethyl]2,4,8,10-tetraoxaspiro[5,5]undecane, tocopherol, 2,2′-ethylidenebis(4,6-di-t-butylphenol), N,N′-bis[3-(3,5-di-t-butyl-4-hydroxyphenyl)propionyl]hydrazine, 2,2′-oxamide bis[ethyl-3-(3,5-di-t-butyl-4-hydroxyphenyl)propionate], 1,1,3-tris(2-methyl-4-hydroxy-5-t-butylphenyl)butane, ethylene-1,2-bis(3,3-bis[3-t-butyl-4-hydroxyphenyl]butyrate), ethylene-1,2-bis(3-[3-t-butyl-4-hydroxyphenyl]butyrate), 1,1-bis(2-methyl-5-t-butyl-4-hydroxyphenyl)butane, 1,1,3-tris(2-methyl-5-t-butyl-4-hydroxyphenyl)butane, 1,3,5-tris(3′,5′-di-t-butyl-4′-hydroxybenzyl)-S-triazine-2,4,6 (1H,3H,5H)-trione, 1,3,5-tris(3′-t-butyl-4′-hydroxy-5-methylbenzyl)-S-triazine-2,4,6 (1H,3H,5H)-trione, 1,3,5-tris(4-t-butyl-3-hydroxy-2,6-dimethylbenzyl)-1,3,5-triazine-2,4,6 (1H,3H,5H)-trione, as well as high-molecular-weight hindered phenolic compounds known as antioxidants for polyurethane elastic yarns, are also suitable.

As preferred specific examples of such high-molecular-weight hindered phenol compounds, an addition polymer of divinylbenzene and cresol, an addition polymer isobutylene adduct of dicyclopentadiene and cresol and a polymer of chloromethylstyrene and a compound such as cresol, ethylphenol or t-butylphenol are used. Here, divinylbenzene and chloromethylstyrene may be p- or m-. Cresol, ethylphenol and t-butylphenol may be o-, m- or p-.

Among them, from the viewpoint of stabilizing the viscosity of the raw-material spinning solution for the polyurethane yarn, suppressing the amount of volatilization loss during spinning and obtaining good spinnability, it is preferable to use a compound having a molecular weight of 300 or more. Furthermore, to efficiently exhibit a high spinning speed, heat resistance during dyeing, resistance against unsaturated fatty acids and resistance against heavy metals, it is preferable to use any among 1,3,5-tris(4-t-butyl-3-hydroxy-2,6-dimethyl benzyl)-1,3,5-triazine-2,4,6 (1H,3H,5H)-trione, tricthyleneglycol-bis[3-(3-t-butyl-5-methyl-4-hydroxyphenyl)propionate], ethylene-1,2-bis(3,3-bis[3-t-butyl-4-hydroxyphenyl]butyrate) and a polymer that is an adduct of divinylbenzene and p-cresol and has a repetition count of 6 to 12 or a combination thereof. Among these, 1,3,5-tris(4-t-butyl-3-hydroxy-2,6-dimethylbenzyl)-1,3,5-triazine-2,4,6 (1H,3H,5H)-trione is particularly preferred. Moreover, when a triazine compound is selected as compound (a) and compound (c), a particularly high synergistic effect can be obtained in terms of heat resistance during dyeing. Among them, compound (a) being 1,3,5-tris(4-t-butyl-3-hydroxy-2,6-dimethylbenzyl)-1,3,5-triazine-2,4,6 (1H,3H,5H)-trione and compound (c) being 2,4-di(2′,4′-dimethylphenyl)-6-(2″-hydroxy-4″-alkoxyphenyl)-1,3,5-triazine is particularly preferred.

Further, the polyurethane elastic fiber of the present invention preferably contains a partially hindered phenol compound from the viewpoint of suppressing deterioration of properties due to recycling, particularly from the viewpoint of suppressing breaking strength and elongation and suppressing discoloration. The partially hindered phenol compound is preferably a compound containing at least two partially hindered hydroxyphenyl groups and having a skeleton selected from bisesters and alkylidenes. Here, the alkyl group present at the ring position adjacent to the hydroxyl group in the hydroxyphenyl group is more preferably a tertiary butyl group, and it is even more desirable that the equivalent weight of the hydroxyl group is 600 or less.

Further, as the phenol compound in the present invention, a partially hindered phenol compound is also preferred. As the partially hindered phenol compound, for example, ethylene-1,2-bis(3,3-bis[3-t-butyl-4-hydroxyphenyl]butyrate) (chemical formula 1 below) of a structure wherein a partially hindered hydroxyphenyl group is covalently bonded to a bisester skeleton is preferred.

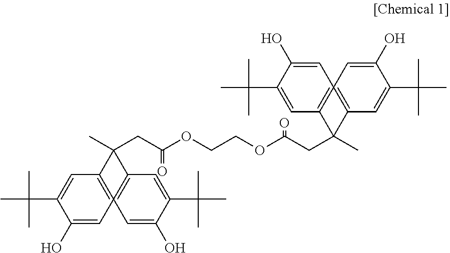

By containing the above-described partially hindered phenol compound, the effect of suppressing deterioration of properties due to recycling can be enhanced. This type of hindered phenol compound contributes to, and is effective in, specifically suppressing the molecular weight of the polyurethane constituting the polyurethane elastic fiber when washing and bleaching are frequently carried out, such as for undergarments. From the viewpoint of making this effect sufficient and not adversely affecting the physical properties of the fiber, the partially hindered phenol compound is preferably contained in an amount of 0.15 to 4% by mass relative to the polyurethane elastic yarn. More preferably, it is contained in an amount of 0.5 to 3.5% by mass, which secures breaking strength and elongation, composite durability, yellowing resistance and, in some cases, light resistance. A more preferable antioxidant content is a range of 0.2% by mass or more and 3.0% by mass or less. Still more preferable is a range of 0.5% by mass or more and 2.0% by mass or less.

Further, the content of the antioxidant in the recycled polyurethane elastic fiber that is recovered and used as a raw material is preferably in a range of 0.1% by mass or more and 5.0% by mass or less. When the content of the antioxidant in the recycled polyurethane elastic fiber is within this range, the content of the antioxidant contained in the polyurethane elastic fiber that is finally produced can be easily controlled to the desirable antioxidant content described above. The antioxidant content of the recycled polyurethane elastic fiber is more preferably 0.2% by mass or more and 3.0% by mass or less and still more preferably in a range of 0.5% by mass or more and 2.0% by mass or less.

More specifically, the antioxidant to be contained is a hindered phenol compound having a molecular weight of 1,000 or more, and a hindered phenol compound having a molecular weight of 1,000 or more known as an antioxidant for polyurethane elastic yarn is preferably used. There are no limitations in particular other than a relatively high molecular weight of 1,000 or more, and as preferred specific examples of such high-molecular-weight hindered phenol compounds, an addition polymer of divinylbenzene and cresol, an addition polymer isobutylene adduct of dicyclopentadiene and cresol and a polymer of chloromethylstyrene and a compound such as cresol, ethylphenol or t-butylphenol are used. Here, divinylbenzene and chloromethylstyrene may be p- or m-. Cresol, ethylphenol and t-butylphenol may be o-, m- or p-.

Among them, a polymer hindered phenol compound derived from cresol is preferable from the viewpoint of stabilizing the viscosity of the starting spinning solution for the polyurethane yarn and obtaining good spinnability. Furthermore, in order to efficiently exhibit a high spinning speed, heat resistance during dyeing, resistance to unsaturated fatty acids, and resistance to heavy metals, it is preferable that a fairly large amount of the high-molecular-weight hindered phenol compound is included. However, from the viewpoint of obtaining better basic physical properties as a polyurethane yarn, it is preferable that the amount is not too large.

When the polyurethane elastic fiber of the present invention contains a tertiary amine compound, this is preferably contained at 0.2% by mass or more and 5.0% by mass or less. When the content of the tertiary amine compound is within this range, practically preferable properties, spinnability, dyeability, durability and yellowing resistance of the polyurethane elastic fiber are improved.

The tertiary amine compound used in the present invention is not particularly limited as long as it is a compound having an amino group in its structure. However, from the viewpoint of chlorine degradation resistance and yellowing of the polyurethane elastic yarn, a compound having, among primary to tertiary amino groups, only a tertiary amino group in the molecule is particularly preferred.

If the number-average molecular weight of the tertiary amine compound is less than 2,000, water-repellent finishing properties are worsened due to rubbing against guides or knitting needles and falling off during knitting of the polyurethane elastic yarn or running off during processing in a bath for dyeing or the like. As such, the number-average molecular weight must be 2,000 or more. Considering solubility in the polyurethane spinning dope, the range of the number-average molecular weight is preferably a range of 2,000 to 10,000. A range of 2,000 to 4,000 is more preferable.

By including the tertiary amine compound, it is possible to improve a recyclability of the polyurethane elastic yarn, particularly a yellowing prevention performance. From the viewpoint of making this effect sufficient and not adversely affecting the physical properties of the fiber, the tertiary amine compound is preferably contained in an amount of 0.2% by mass or more and 5.0% by mass or less based on the mass of the fiber. It is more preferably contained at 0.5% by mass or more and 4.0% by mass or less. A more preferable tertiary-amine-compound content is a range of 0.5% by mass or more and 3.0% by mass or less. Still more preferable is a range of 0.5% by mass or more and 2.0% by mass or less.

More specifically, as the tertiary amine compound to be contained, a linear polymer compound having a number-average molecular weight of 2,000 or more obtained by the reaction of t-butyldiethanolamine and methylene-bis-(4-cyclohexylisocyanate); polyethylenimine; high-molecular-weight compounds having branched structures containing primary amino groups, secondary amino groups and tertiary amino groups in the molecular skeleton and the like can be mentioned.

As a typical example, in recycling wherein a fiber that is nonstandard in terms of an industrial product, due to some defect immediately after production—that is, waste yarn—is blended at a high concentration, in repeating this, breaking strength and elongation reduction is remarkable. In order to avoid such deterioration of properties, as described above, it is effective to blend a polyurethane source having a low content of a high-molecular-weight tertiary amine compound, a decomposition product thereof, a high-molecular-weight antioxidant and a decomposition product thereof to reduce the contained additive concentration. In terms of an indicator, it is preferable to blend a polyurethane wherein a number-average molecular weight based on gel permeation chromatography (GPC) is 20,000 or more and 120,000 or less and no peak or shoulder is present in a detection intensity curve in a region wherein this molecular weight based on GPC is 30,000 or less. Considering the breaking strength and elongation of the polyurethane elastic fiber, the range of the number-average molecular weight is preferably 30,000 or more and 100,000 or less. More preferably, it is a range of 40,000 or more and 80,000 or less. The detection intensity curve is a differential molecular-weight distribution curve (the horizontal axis is the molecular weight, and the vertical axis is the value obtained by differentiating the concentration fraction by the logarithm of the molecular weight), and the shoulder is a shoulder peak.

Note that in the present invention, a molecular weight of the polyurethane elastic fiber using a recycled polyurethane elastic fiber as a portion of its raw materials may also be in a range of 10,000 or more and 50,000 or less in terms of a number-average molecular weight when a tertiary amine compound of a number-average molecular weight in a range of 2,000 to 10,000 or, preferably, an antioxidant of a molecular weight of 1,000 or more is blended. In addition, the molecular weight is measured by GPC and converted by polystyrene.

Furthermore, for two carbonyl stretching vibrations of a urethane bond based on an infrared spectrum (IR) of the recycled polyurethane elastic fiber, regarding Av C—O 1,730 cm⁻¹ and Av C═O 1,710 cm⁻¹ that are the absorbances thereof, it is more preferable to blend a polyurethane wherein a ratio of Av C—O 1,730 cm⁻¹ to Av C═O 1,710 cm⁻¹—that is, Av C═O 1,730 cm⁻¹/Av C═O 1,710 cm⁻¹—is 1.05 or more and 1.50 or less.

Such a recycled polyurethane raw-material source arises when its application is achieved by a clothing product that is washed frequently; this is more preferable. In many cases, this can be achieved by using underwear recovered from the market—that is, used undergarments. The reason for this is repeated washing with an anionic surfactant; this is suitable for use as a raw material for recycled polyurethane elastic fibers.

### EXAMPLES

### Examples 1 to 17, Comparative Examples 1 to 8

Hereinafter, regarding Examples 1 to 17 and Comparative Examples 1 to 8 shown in Table 1, the production and evaluation of polyurethane elastic fibers obtained by recovering polyurethane from recovered fabrics and adding recycled polyurethane fibers will be described.

### <Production of Dry-Spun Polyurethane Elastic Fiber>

In Comparative Example 1, an N,N′-dimethylacetamide (hereinafter abbreviated as DMAc) solution (35% by mass) of polyurethane composed of tetramethylene ether glycol having a molecular weight of 2,000, bis-(p-isocyanatophenyl)-methane and ethylenediamine was polymerized to obtain a polymer solution PUU1.

Next, as an antioxidant, a 1:1 (mass ratio) mixture of a polyurethane produced by the reaction of t-butyldiethanolamine and methylene-bis-(4-cyclohexylisocyanate) (“Methacrol” (registered trademark) 2462 manufactured by DuPont) and a condensation polymer of p-cresol and divinylbenzene (“Methacrol” (registered trademark) 2390 manufactured by DuPont) was used. A DMAc solution (35% by mass) of this mixture was prepared, and this was used as additive solution (B).

The above solution PUU1, additive solution (B), and ethylenediamine (C) were uniformly mixed 99% by mass, 1.0% by mass, and 0.1% by mass, respectively, to obtain spinning solution (D).

The spinning dope thus obtained was dry-spun at a dry nitrogen temperature of 300° C. or higher so that DMAc and floating ethylenediamine in the spinning solution would become 1/100 or less of the content of the spinning dope. At this time, a speed ratio between a godet roller and a winding machine was set to 1:1.20, and a 22 dtex/3 fil multifilament polyurethane elastic fiber was spun. A processing agent (oil agent) described later was applied by a pre-winding oiling roller, and winding was performed on a cylindrical paper tube of a winding speed of 600 m/min and a length of 58 mm via a traverse guide imparting a winding width of 38 mm, using a surface-drive winding machine. 500 g of a wound yarn body was obtained as a dry-spun polyurethane elastic fiber. The resulting polyurethane elastic fiber was a fused yarn in which three filaments were fused together.

In Example 1, a knitted item (an undershirt sewn from a circular-knitted fabric that was repeatedly washed) with a PU (polyurethane) content of 10% was used as a raw material, and a three-blade helical-cutting pulverizer was used to pulverize the fabric to a size of 0.5 mm. After that, using an aqueous calcium chloride solution, a heavy liquid having a specific gravity of 1.3 was prepared, and the pulverized material was added thereto at a bath ratio (heavy-liquid mass:fabric mass) of 200:1 and stirred for 5 minutes. Thereafter, the aqueous solution was allowed to stand for 6 hours, and after confirming that the fibers had separated into layers, the polyurethane fibers were recovered. The recovered polyurethane fibers were washed with water at 60° C. and air-dried. Afterward, the recovered polyurethane fibers were dissolved in DMAc to obtain a recovered polyurethane solution, which was then added to spinning solution (D) so that the recycled polymer content in the yarn would be 20%. Spinning was carried out in the same manner as in Comparative Example 1 using this as a spinning dope.

In Example 2, as shown in Table 1, a polyurethane elastic fiber was obtained in the same manner as in Example 1. However, 1% by mass of an ionic surfactant (didecyldimethylammonium sulfonate) was added to the heavy liquid in the wet gravity separation step.

In Examples 3 to 10, as shown in Table 1, a polyurethane elastic fiber was obtained in the same manner as in Example 1.

In Example 11, as shown in Table 1, a polyurethane elastic fiber was obtained in the same manner as in Example 1. However, in the wet gravity separation step, after the heavy liquid was stirred, ultrasonic waves with an ultrasonic output of 100 W and an ultrasonic frequency of 20 kHz were applied for 5 minutes by an ultrasonic generator before letting this stand still.

In Examples 12 to 15, as shown in Table 1, a polyurethane elastic fiber was obtained in the same manner as in Example 1.

In Example 16, as shown in Table 1, a polyurethane elastic fiber was obtained in the same manner as in Example 1. However, the polyurethane elastic fiber was obtained so a content of 6% in the yarn would be achieved for a 1:1 (mass ratio) mixture of a polyurethane produced by the reaction of t-butyldiethanolamine and methylene-bis-(4-cyclohexylisocyanate) (“Methacrol” (registered trademark) 2462 manufactured by DuPont) and a condensation polymer of p-cresol and divinylbenzene (“Methacrol” (registered trademark) 2390 manufactured by DuPont), this mixture being the antioxidant.

In Example 17, as shown in Table 1, a polyurethane elastic fiber was obtained in the same manner as in Example 1. However, although uneconomical, the heavy liquid in the wet gravity separation process was made from expensive sodium polytungstate as a solute.

In Comparative Example 2, as shown in Table 1, a polyurethane elastic fiber was obtained in the same manner as in Example 1. However, the size of the pulverized material was 12 mm.

In Comparative Example 3, as shown in Table 1, a polyurethane elastic fiber was obtained in the same manner as in Example 1. However, the size of the pulverized material was 2.5 mm.

In Comparative Example 4, as shown in Table 1, a polyurethane elastic fiber was obtained in the same manner as in Example 1. However, the specific gravity in the heavy liquid in the wet gravity separation step was 1.05.

In Comparative Example 5, as shown in Table 1, a polyurethane elastic fiber was obtained in the same manner as in Example 1. However, the specific gravity in the heavy liquid in the wet gravity separation step was 2.45.

In Comparative Examples 6 to 8, as shown in Table 1, a polyurethane elastic fiber was obtained.

In Table 1, “Content” is the value per 100 parts by mass of polymer solid content in the spinning dope. In Table 1, “Recycled polymer” refers to a raw-material recycled polyurethane fiber extracted from old undergarments of a circular-knitted fabric that were washed frequently wherein a GPC-based number-average molecular weight is 63,000, no peak or shoulder is present in a detection intensity curve in a region wherein the GPC-based molecular weight is 30,000 or less and an IR-based Av C—O 1,730 cm⁻¹/Av C═O 1,710 cm⁻¹ is 1.48.

Next, the dry-spun polyurethane elastic fibers (hereinafter referred to as sample yarns) obtained above were subjected to the following evaluations.

### <Breaking Elongation, Breaking Strength, Permanent Set Rate>

The breaking elongation, breaking strength, permanent set rate, and stress relaxation rate were measured by subjecting the polyurethane elastic yarn to a tensile test using an Instron 5564 type tensile tester, and each property was evaluated according to the following criteria.

A sample with a test length of 5 cm (L1) was subjected to 300% elongation five times at a tensile speed of 50 cm/min. At this time, the stress at 300% elongation was defined as (G1). The length of the sample was then held at 300% elongation for 30 seconds. The stress after holding for 30 seconds was defined as (G2). Next, the length of the sample when the elongation of the sample was restored and the stress became 0 was defined as (L2). This 300% stretch, hold and restoration procedure was repeated until the sample broke at the sixth stretch. The stress at break was defined as (G3), and the sample length at break was defined as (L3). Hereinafter, the above characteristics are calculated by the following formulas.

Breaking strength (cN)=(G3)
20 or more: ⊚, 17 to 20: ◯, 14 to 17: Δ, 14 or less: x

Breaking elongation (%)=100×((L3)−(L1))/(L1)
480 or more: ⊚, 460 to 480: ◯, 430 to 460: Δ, 430 or less: x

Permanent set rate (%)=100×((L2)−(L1))/(L1)
20 or less: ⊚, 20 to 22: ◯ 22 to 24: Δ, 24 or more: x

### <Amount of Water Used>

An evaluation was made of the amount of water used for recovering polyurethane fibers by wet gravity separation in the present invention. The amount used mainly includes the amount of aqueous solution used for wet gravity separation and the amount used for water washing. Since the amount of water affects equipment size, it is desirable to reduce it as much as possible. The amount of water used to recover 1 kg of recovered polyurethane fibers was evaluated as follows.
100 L or less: ◯, 100 L to 250 L: Δ, 250 L or more: x

Molecular weight measurement by GPC was carried out under the following conditions.
Column: Two SHODEX KF-806M manufactured by Showa Denko K.K.
Solvent: N,N-dimethylacetamide 1 mL/min
Temperature: 40° C.
Detector: Differential refractometer (RI detector)

The IR spectrum was measured by the KBr tablet method using an FT/IR7300 infrared spectrometer manufactured by JASCO Corporation.

The overall evaluations ⊚, ◯ and Δ in Table 1 were regarded as acceptable, and x was regarded as unacceptable. The weighting in the overall evaluation was mainly the PU recovery rate (%) (40%), the elastic fiber properties (40%), and the amount of water used (20%).

TABLE 1

| | | Size of | | | | | | | Specific | Bath ratio |
|---|---|---|---|---|---|---|---|---|---|---|
| | | pulverized | Presence or | | Surfactant | Use of | Ultrasonic | Ultrasonic | gravity of | (Heavy |
| | | material | absence of | Type of | concentration | ultrasonic | output | frequency | heavy | liquid:pulverized |
| | | (mm) | surfactant | surfactant | (% by mass) | wave | (W) | (kHz) | liquid | fiber material) |
| Example | 1 | 0.5 | Absent | — | — | No | — | — | 1.3 | 700:1 |
| | 2 | 0.5 | Present | Ionic | 1 | No | — | — | 1.3 | 700:1 |
| | 3 | 0.5 | Present | Ionic | 1 | No | — | — | 1.3 | 200:1 |
| | 4 | 0.5 | Present | Ionic | 1 | No | — | — | 1.3 | 50:1 |
| | 5 | 0.5 | Present | Nonionic | 1 | No | — | — | 1.3 | 200:1 |
| | 6 | 0.5 | Present | Nonionic | 1 | No | — | — | 1.3 | 100:1 |
| | 7 | 0.5 | Present | Nonionic | 1 | No | — | — | 1.3 | 50:1 |
| | 8 | 0.5 | Present | Ionic | 0.1 | No | — | — | 1.3 | 200:1 |
| | 9 | 0.5 | Present | Ionic | 10 | No | — | — | 1.3 | 200:1 |
| | 10 | 0.5 | Present | Ionic | 1 | No | — | — | 1.3 | 200:1 |
| | 11 | 0.5 | Absent | | — | Yes | 100 | 20 | 1.3 | 200:1 |
| | 12 | 0.5 | Present | Ionic | 1 | Yes | 100 | 20 | 1.3 | 200:1 |
| | 13 | 0.5 | Present | Ionic | 1 | Yes | 150 | 55 | 1.1 | 200:1 |
| | 14 | 0.05 | Present | Ionic | 1 | Yes | 100 | 55 | 1.3 | 200:1 |
| | 15 | 0.01 | Present | Ionic | 1 | Yes | 100 | 55 | 1.3 | 200:1 |
| | 16 | 0.5 | Absent | | — | No | — | — | 1.3 | 200:1 |
| | 17 | 0.5 | Present | Ionic | 1 | No | — | — | 1.3 | 200:1 |
| Compar- | 1 | — | — | — | — | — | — | — | — | — |
| ative | 2 | 12 | Present | Ionic | 1 | No | — | — | 1.3 | 200:1 |
| example | 3 | 2.5 | Present | Ionic | 1 | No | — | — | 1.3 | 200:1 |
| | 4 | 0.5 | Present | Ionic | 1 | No | — | — | 1.05 | 200:1 |
| | 5 | 0.5 | Present | Ionic | 1 | No | — | — | 2.45 | 200:1 |
| | 6 | 0.5 | Present | Ionic | 1 | No | — | — | 1.3 | 15:1 |
| | 7 | 0.5 | Present | Ionic | 1 | No | — | — | 1.3 | 100:1 |
| | 8 | 0.5 | Present | Ionic | 1 | No | — | — | 1.3 | 1000:1 |

| | | PU | Recycled | | | | | |
|---|---|---|---|---|---|---|---|---|
| | Type of | recovery | polyurethane | | | Permanent | Amount | |
| | heavy | rate | fiber | Breaking | Breaking | set rate | of water | Overall |
| | liquid | (%) | content | elongation | strength | (%) | used | evaluation |
| Example | Aqueous CaCl₂ | 40 | 20 | 585 | 25 | 22 | Δ | ◯ |
| | solution | | | | | | | |
| | Aqueous CaCl₂ | 80 | 20 | 510 | 21 | 21 | Δ | ◯ |
| | solution | | | | | | | |
| | Aqueous CaCl₂ | 82 | 20 | 580 | 25 | 22 | Δ | ◯ |
| | solution | | | | | | | |
| | Aqueous CaCl₂ | 52 | 20 | 585 | 26 | 23 | ◯ | ⊚ |
| | solution | | | | | | | |
| | Aqueous CaCl₂ | 50 | 20 | 510 | 25 | 22 | Δ | ◯ |
| | solution | | | | | | | |
| | Aqueous CaCl₂ | 43 | 20 | 510 | 26 | 22 | Δ | ◯ |
| | solution | | | | | | | |
| | Aqueous CaCl₂ | 30 | 20 | 580 | 25 | 22 | ◯ | ◯ |
| | solution | | | | | | | |
| | Aqueous CaCl₂ | 50 | 20 | 585 | 26 | 22 | Δ | ◯ |
| | solution | | | | | | | |
| | Aqueous CaCl₂ | 79 | 20 | 580 | 22 | 23 | Δ | ⊚ |
| | solution | | | | | | | |
| | Aqueous CaCl₂ | 63 | 20 | 510 | 25 | 22 | Δ | ⊚ |
| | solution | | | | | | | |
| | Aqueous CaCl₂ | 60 | 20 | 500 | 23 | 24 | Δ | ◯ |
| | solution | | | | | | | |
| | Aqueous CaCl₂ | 88 | 20 | 505 | 20 | 23 | Δ | ⊚ |
| | solution | | | | | | | |
| | Aqueous CaCl₂ | 83 | 20 | 500 | 25 | 23 | Δ | ⊚ |
| | solution | | | | | | | |
| | Aqueous CaCl₂ | 92 | 20 | 500 | 26 | 23 | Δ | ⊚ |
| | solution | | | | | | | |
| | Aqueous CaCl₂ | 94 | 20 | 505 | 25 | 22 | Δ | ⊚ |
| | solution | | | | | | | |
| | Aqueous CaCl₂ | 40 | 20 | 480 | 27 | 23 | Δ | ◯ |
| | solution | | | | | | | |
| | Aqueous CaCl₂ | 15 | 20 | 495 | 25 | 22 | Δ | Δ |
| | solution | | | | | | | |
| Compar- | Sodium | — | 20 | 570 | 28 | 20 | — | — |
| ative | polytungstate | | | | | | | |
| example | Aqueous CaCl₂ | 5 | 20 | — | — | — | Δ | X |
| | solution | | | | | | | |
| | Aqueous CaCl₂ | 5 | 20 | — | — | — | Δ | X |
| | solution | | | | | | | |
| | Aqueous CaCl₂ | 10 | 20 | 490 | 25 | 22 | Δ | X |
| | solution | | | | | | | |
| | Aqueous CaCl₂ | 10 | 20 | 360 | 28 | 25 | Δ | X |
| | solution | | | | | | | |
| | Aqueous CaCl₂ | 20 | 20 | 360 | 28 | 25 | ◯ | X |
| | solution | | | | | | | |
| | Aqueous CaCl₂ | 25 | 20 | 420 | 27 | 24 | Δ | X |
| | solution | | | | | | | |
| | Aqueous CaCl₂ | 90 | 20 | 505 | 25 | 27 | X | X |
| | solution | | | | | | | |

What is claimed is:

1. A recycled-material polyurethane elastic fiber using a recovered fabric containing a polyurethane fiber, wherein a component separated by wet gravity separation of the fabric is used as at least a portion of raw materials.

2. The polyurethane elastic fiber of claim 1, wherein the fabric is subjected to the wet gravity separation by being pulverized to a size of 0.005 mm or more and 0.5 mm or less.

3. The polyurethane elastic fiber of claim 1, wherein a surfactant is used in the wet gravity separation.

4. The polyurethane elastic fiber of claim 3, wherein the surfactant is an ionic surfactant that is liquid at room temperature.

5. The polyurethane elastic fiber of claim 3, wherein a concentration of the surfactant is in a range of 0.1% by mass or more and 50% by mass or less.

6. The polyurethane elastic fiber of claim 1, wherein an ultrasonic wave is used in the wet gravity separation.

7. The polyurethane elastic fiber of claim 6, wherein an intensity of the ultrasonic wave has an output of 20 W or more and 2,000 W or less per 1 kg of a heavy liquid of wet gravity separation wherein the fabric is soaked, and a frequency of the ultrasonic wave is in a range of 20 kHz or more and 100 kHz or less.

8. The polyurethane elastic fiber of claim 1, wherein a specific gravity of a heavy liquid of the wet gravity separation is in a range of 1.10 or more and 2.40 or less.

9. The polyurethane elastic fiber of claim 1, wherein a bath ratio (heavy-liquid mass:fabric mass) of the wet gravity separation is in a range of 20:1 to 500:1.

10. The polyurethane elastic fiber of claim 1, wherein a heavy liquid of the wet gravity separation is an aqueous calcium chloride solution.

11. The polyurethane elastic fiber of claim 1, wherein a number-average molecular weight based on gel permeation chromatography (GPC) of the polyurethane contained in the fabric is 20,000 or more and 120,000 or less, and no peak or shoulder is present in a detection intensity curve in a region wherein this molecular weight based on GPC is 30,000 or less.

12. The polyurethane elastic fiber of claim 1, wherein Av C═O 1,730-1/Av C═O 1,710-1 based on an infrared spectrum (IR) of the polyurethane fiber contained in the fabric is 1.05 or more and 1.50 or less.

13. The polyurethane elastic fiber of claim 1, wherein application of the fabric is as a clothing product that is washed with high frequency.

14. The polyurethane elastic fiber of claim 13, wherein application of the fabric is as an undergarment.

15. A method of producing a recycled-material polyurethane elastic fiber using a recovered fabric containing a polyurethane fiber, wherein a component separated by wet gravity separation of the fabric is used as at least a portion of raw materials.

16. The method of producing a polyurethane elastic fiber of claim 15, wherein the fabric is subjected to the wet gravity separation by being pulverized to a size of 0.005 mm or more and 0.5 mm or less.

17. The method of producing a polyurethane elastic fiber of claim 15, wherein a surfactant is used in the wet gravity separation.

18. The method of producing a polyurethane elastic fiber of claim 17, wherein the surfactant is an ionic surfactant that is liquid at room temperature.

19. The method of producing a polyurethane elastic fiber of claim 17, wherein a concentration of the surfactant is in a range of 0.1% by mass or more and 50% by mass or less.

20. The method of producing a polyurethane elastic fiber of claim 15, wherein an ultrasonic wave is used in the wet gravity separation.

21. The method of producing a polyurethane elastic fiber of claim 20, wherein an intensity of the ultrasonic wave has an output of 20 W or more and 2,000 W or less per 1 kg of a heavy liquid of wet gravity separation wherein the fabric is soaked, and a frequency of the ultrasonic wave is in a range of 20 kHz or more and 100 kHz or less.

22. The method of producing a polyurethane elastic fiber of claim 15, wherein a specific gravity of a heavy liquid of the wet gravity separation is in a range of 1.10 or more and 2.40 or less.

23. The method of producing a polyurethane elastic fiber of claim 15, wherein a bath ratio (heavy-liquid mass:fabric mass) of the wet gravity separation is 20:1 to 500:1.

24. The method of producing a polyurethane elastic fiber of claim 15, wherein a heavy liquid of the wet gravity separation is an aqueous calcium chloride solution.
